(19) United States
(12) Patent Application Publication
(10) Pub. No.: US 2013/0066559 A1
(43) Pub. Date: Mar. 14, 2013

(54) INTERPRETING BOREHOLE TRANSIENT ELECTROMAGNETIC DATA USING TWO THIN-SHEET CONDUCTORS

(71) Applicant: Sheng Fang, Houston, TX (US)

(72) Inventor: Sheng Fang, Houston, TX (US)

(73) Assignee: BAKER HUGHES INCORPORATED, Houston, TX (US)

(21) Appl. No.: 13/230,071

(22) Filed: Sep. 12, 2011

(51) Int. Cl. G06F 19/00; G01V 3/10

(52) U.S. Cl. 702/11; 324/338

(57) ABSTRACT

An apparatus and method for estimating a parameter of interest of an earth formation involving an electromagnetic transient response of an earth formation and a two thin-sheet conductor model of the earth formation. The method may include generating an electromagnetic transient response in the earth formation, generating a signal indicative of the response, and estimating the at least one parameter of interest using the signal. The method may also include estimating a boundary distance using the at least one parameter of interest. The apparatus may include at least one antenna configured to generate the electromagnetic response in the earth formation and at least one processor configured to estimate the at least one processor based on the electromagnetic transient response.

### FIELD OF THE DISCLOSURE

This disclosure generally relates to exploration for hydrocarbons involving electrical investigations of a borehole penetrating an earth formation.

### BACKGROUND OF THE DISCLOSURE

Electrical earth borehole logging is well known and various devices and various techniques have been described for this purpose. Broadly speaking, there are two categories of devices used in electrical logging devices. In the first category, a transmitter (such as a guard electrode) is uses in conjunction with a diffuse return electrode (such as the tool body). A measured electric current flows in a circuit that connects a voltage source to the transmitter, through the earth formation to the return electrode and back to the voltage source in the tool. A second or center electrode is fully or at least partially surrounded by said guard electrode. Provided both electrodes are kept at the same potential, a current flowing through the center electrode is focused into the earth formation by means of the guard electrode. Generally, the center electrode current is several orders of magnitude smaller than the guard current.

The second category includes inductive measuring tools, such as when an antenna within the measuring instrument induces a current flow within the earth formation. The magnitude of the induced current is detected using either the same antenna or a separate receiver antenna. The present disclosure belongs to the second category.

### SUMMARY OF THE DISCLOSURE

In aspects, the present disclosure is related to methods and apparatuses estimating at least one parameter of interest using a response of an earth formation to an electromagnetic transient.

One embodiment according to the present disclosure includes a method of estimating at least one parameter of interest of an earth formation, comprising: estimating the at least one parameter of interest using a two thin-sheet conductor model with electromagnetic transient information obtained using a receiver in a borehole penetrating the earth formation.

Another embodiment according to the present disclosure includes an apparatus for estimating a parameter of interest of an earth formation, comprising: at least one antenna configured to generate an electromagnetic transient response in the earth formation and configured to generate a electromagnetic transient information based on the electromagnetic transient response; and at least one processor configured to estimate at least one parameter of interest of the earth formation using the electromagnetic transient information.

Another embodiment according to the present disclosure includes a non-transitory computer-readable medium product having stored thereon instructions that, when executed by at least one processor, perform a method, the method comprising: estimating at least one parameter of interest using a two thin-sheet conductor model with electromagnetic transient information obtained using a receiver in a borehole penetrating the earth formation.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of an electromagnetic (EM) tool deployed in a wellbore along a drill string according to one embodiment of the present disclosure;

FIG. 2 shows a schematic close up of one embodiment of the EM tool configured for deployment in a wellbore according to one embodiment of the present disclosure;

FIG. 3 shows an earth formation modeled as two thin-sheet conductors according to one embodiment of the present disclosure;

FIG. 4 shows a flow chart of a method for estimating at least one parameter of interest according to one embodiment of the present disclosure;

FIG. 5 graphically illustrates conductance above and below the tool according to one embodiment of the present disclosure;

FIG. 6A graphically illustrates resistivity above the tool according to one embodiment of the present disclosure; and

FIG. 6B graphically illustrates resistivity below the tool according to one embodiment of the present disclosure.

### DETAILED DESCRIPTION

This disclosure generally relates to exploration for hydrocarbons involving electromagnetic investigations of a borehole penetrating an earth formation. These investigations may include estimating at least one parameter of interest of the earth formation using electromagnetic transient responses of the earth formation to an electromagnetic signal where the earth formation may be modeled as two thin-sheet conductors.

The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein. Indeed, as will become apparent, the teachings of the present disclosure can be utilized for a variety of well tools and in all phases of well construction and production. Accordingly, the embodiments discussed below are merely illustrative of the applications of the present disclosure.

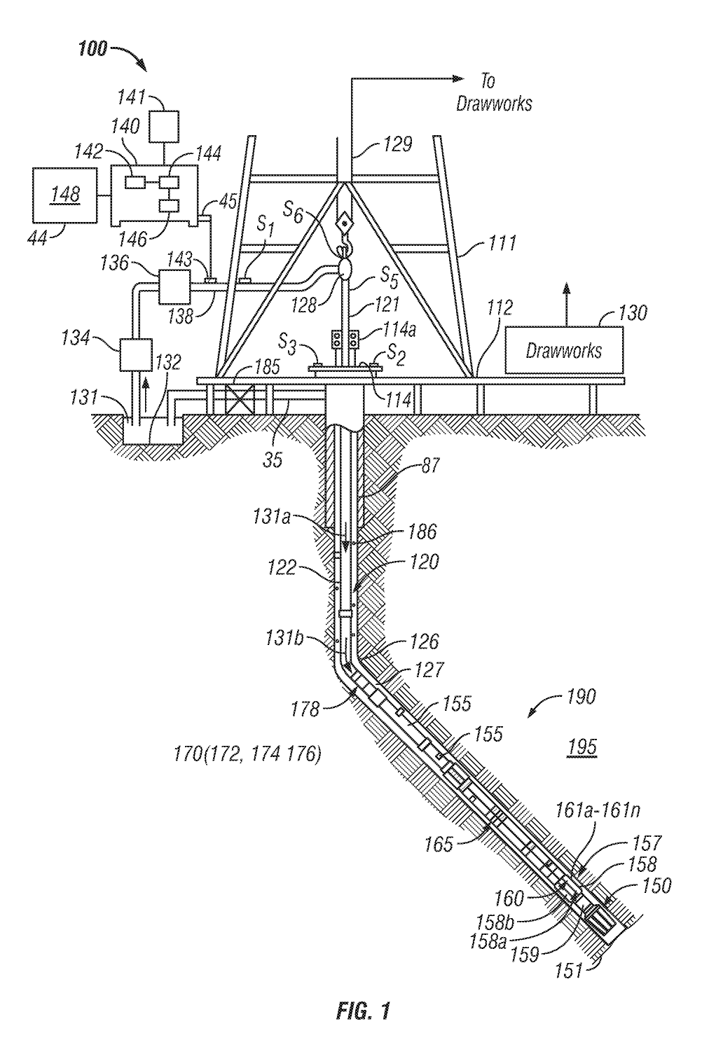

FIG. 1 is a schematic diagram of an exemplary drilling system 100 that includes a drill string having a drilling assembly attached to its bottom end that includes a steering unit according to one embodiment of the disclosure. FIG. 1 shows a drill string 120 that includes a drilling assembly or bottomhole assembly (BHA) 190 conveyed in a borehole 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe) 122, having the drilling assembly 190, attached at its bottom end extends from the surface to the bottom 151 of the borehole 126. A drill bit 150, attached to drilling assembly 190, disintegrates the geological formations when it is rotated to drill the borehole 126. The drill string 120 is coupled to a drawworks 130 via a Kelly joint 121, swivel 128 and line 129 through a pulley. Drawworks 130 is operated to control the weight on bit (“WOB”). The drill string 120 may be rotated by a top drive (not shown) instead of by the prime mover and the rotary table 114. Alternatively, a coiled-tubing may be used as the tubing 122. A tubing injector 114a may be used to convey the coiled-tubing having the drilling assembly attached to its bottom end. The operations of the drawworks 130 and the tubing injector 114a are known in the art and are thus not described in detail herein.

A suitable drilling fluid 131 (also referred to as the “mud”) from a source 132 thereof, such as a mud pit, is circulated under pressure through the drill string 120 by a mud pump 134. The drilling fluid 131 passes from the mud pump 134 into the drill string 120 via a desurger 136 and the fluid line 138. The drilling fluid 131a from the drilling tubular discharges at the borehole bottom 151 through openings in the drill bit 150. The returning drilling fluid 131b circulates uphole through the annular space 127 between the drill string 120 and the borehole 126 and returns to the mud pit 132 via a return line 135 and drill cutting screen 185 that removes the drill cuttings 186 from the returning drilling fluid 131b. A sensor S₁ in line 138 provides information about the fluid flow rate. Herein, the term “information” may relate to, but is not limited to, raw data, processed data, and signals. A surface torque sensor S₂ and a sensor S₃ associated with the drill string 120 respectively provide information about the torque and the rotational speed of the drill string 120. Tubing injection speed is determined from the sensor S₅, while the sensor S₆ provides the hook load of the drill string 120.

In some applications, the drill bit 150 is rotated by only rotating the drill pipe 122. However, in many other applications, a downhole motor 155 (mud motor) disposed in the drilling assembly 190 also rotates the drill bit 150. The rate of penetration for a given BHA largely depends on the WOB or the thrust force on the drill bit 150 and its rotational speed.

The mud motor 155 is coupled to the drill bit 150 via a drive shaft disposed in a bearing assembly 157. The mud motor 155 rotates the drill bit 150 when the drilling fluid 131 passes through the mud motor 155 under pressure. The bearing assembly 157, in one aspect, supports the radial and axial forces of the drill bit 150, the down-thrust of the mud motor 155 and the reactive upward loading from the applied weight-on-bit.

A surface control unit or controller 140 receives signals from the downhole sensors and devices via a sensor 143 placed in the fluid line 138 and signals from sensors S₁-S₆ and other sensors used in the system 100 and processes such signals according to programmed instructions provided to the surface control unit 140. The surface control unit 140 displays desired drilling parameters and other information on a display/monitor 143 that is utilized by an operator to control the drilling operations. The surface control unit 140 may be a computer-based unit that may include a processor 142 (such as a microprocessor), a storage device 144, such as a solid-state memory, tape or hard disc, and one or more computer programs 146 in the storage device 144 that are accessible to the processor 142 for executing instructions contained in such programs. The surface control unit 140 may further communicate with a remote control unit 148. The surface control unit 140 may process data relating to the drilling operations, data from the sensors and devices on the surface, data received from downhole, and may control one or more operations of the downhole and surface devices. The data may be transmitted in analog or digital form.

The drilling assembly 190 may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the earth formation 195 surrounding the drilling assembly 190. Such sensors are generally known in the art and for convenience are generally denoted herein by numeral 165. The drilling assembly 190 may further include a variety of other sensors and devices 159 for determining one or more properties of the drilling assembly 190 (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 159.

The drilling assembly 190 includes a steering apparatus or tool 158 for steering the drill bit 150 along a desired drilling path. In one aspect, the steering apparatus may include a steering unit 160, having a number of force application members 161a-161n, wherein the steering unit is at partially integrated into the drilling motor. In another embodiment the steering apparatus may include a steering unit 158 having a bent sub and a first steering device 158a to orient the bent sub in the wellbore and the second steering device 158b to maintain the bent sub along a selected drilling direction.

The MWD system may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to, drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED. Suitable systems are also discussed in “Downhole Diagnosis of Drilling Dynamics Data Provides New Level Drilling Process Control to Driller”, SPE 49206, by G. Heisig and J. D. Macpherson, 1998.

The MWD system 100 can include one or more downhole processors at a suitable location such as 193 on the drilling assembly 190. The processor(s) can be a microprocessor that uses a computer program implemented on a suitable machine readable medium that enables the processor to perform the control and processing. The machine readable medium may include ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, the MWD system utilizes mud pulse telemetry to communicate data from a downhole location to the surface while drilling operations take place. The surface processor 142 can process the surface measured data, along with the data transmitted from the downhole processor, to evaluate formation lithology. The sensors 165 may include an electromagnetic (EM) tool 170.

While a drill string 120 is shown as a conveyance system for sensors 165, it should be understood that embodiments of the present disclosure may be used in connection with tools conveyed via rigid (e.g. jointed tubular or coiled tubing) as well as non-rigid (e.g. wireline, slickline, e-line, etc.) conveyance systems. A downhole assembly (not shown) may include a bottomhole assembly and/or sensors and equipment for implementation of embodiments of the present disclosure on either a drill string or a wireline.

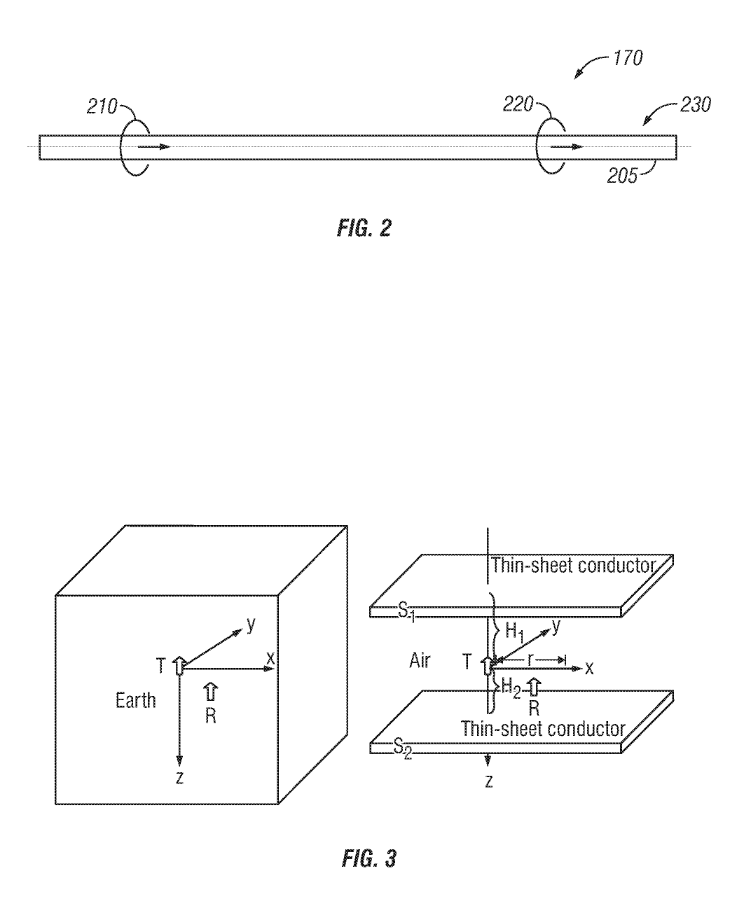

FIG. 2 shows an embodiment of an EM tool 170 suitable for use with the present disclosure. EM tool 170 may include a housing 205, at least one antenna configured as a transmitter coil 210. The transmitter coil 210 may be configured to generate an electromagnetic transient response within the earth formation 195. In some embodiments, the transmitter coil 210 may have a dipole moment that is parallel to the tool axis direction 230. In other embodiments, the transmitter coil 210 may have a dipole moment that is perpendicular to the tool axis direction 230. EM tool 170 may also include at least one antenna configured as a receiver coil 220. The receiver coil 220 may be configured to generate electromagnetic transient information based on the electromagnetic transient response of the earth formation 195. The electromagnetic transient information may be communicated to at least one processor such as surface processor 142 or a downhole processor on BHA 190. In some embodiments, the receiver coil 220 may have an orientation substantially identical to the transmitter coil 210. In other embodiments, the receiver coil 220 may have an orientation substantially orthogonal to the transmitter coil 210. Housing 205 may be part of or independent of drill string 120. The transmitter coil 210 may be spaced apart from receiver coil 230 by a distance along the longitudinal axis of housing 205. In some embodiments, a single antenna may be configured to operate as transmitter coil 210 and receiver coil 220.

FIG. 3 shows a model of an earth formation 195 as two thin-sheet conductors 310, 320. An electromagnetic transient response in an earth formation 195 may be modeled as if the earth formation 195 is a thin-sheet conductor. However, since a tool in a borehole 126 has a part of the earth formation 195 above and part of the earth formation 195 below the tool 170, the model may consider the earth formation 195 to be two thin-sheet conductors 310, 320. The transient response from two thin-sheet conductors may be expressed as:

$$V \approx V {\vert}_{z = - {H}_{1}} + V {\vert}_{z = {H}_{2}} = \frac{{Mm}_{-}}{2 π {S}_{1}} \cdot \frac{9 {r}^{2} - 6 {m}_{-}^{2}}{{[ {r}^{2} + {m}_{-}^{2} ]}^{7 / 2}} + \frac{{Mm}_{+}}{2 π {S}_{2}} \cdot \frac{9 {r}^{2} - 6 {m}_{+}^{2}}{{[ {r}^{2} + {m}_{+}^{2} ]}^{7 / 2}}$$

$$where$$

$${m}_{-} = 2 {H}_{1} + \frac{2 t}{{μ}_{0} {S}_{1}} + h$$

$${m}_{+} = 2 {H}_{2} + \frac{2 t}{{μ}_{0} {S}_{2}} - h$$

V is a voltage of an electromagnetic transient detected at the receiver coil 220, M is an electric moment of a transmitter coil 210, r is a horizontal distance from the transmitter coil 210, H₁ is the distance to the upper sheet 310, H₂ is the distance to the lower sheet 320, S₁ is the conductance of the upper sheet 310, S₂ is the conductance of the lower sheet 320, μ₀ is magnetic permeability, z is a vertical distance from the transmitter coil 210, h is a vertical distance between the transmitter coil 210 and the receiver coil 220, and t is time. The equations at three depths for one exemplary two thin-sheet conductor model may be expressed as:

$${V}_{0} = V {\vert}_{z = - {H}_{1}} + V {\vert}_{z = {H}_{2}} = \frac{{Mm}_{-}}{2 π {S}_{1}} \cdot \frac{9 {r}^{2} - 6 {m}_{-}^{2}}{{[ {r}^{2} + {m}_{-}^{2} ]}^{7 / 2}} + \frac{{Mm}_{+}}{2 π {S}_{2}} \cdot \frac{9 {r}^{2} - 6 {m}_{+}^{2}}{{[ {r}^{2} + {m}_{+}^{2} ]}^{7 / 2}}$$

$${m}_{-} = 2 {H}_{1} + \frac{2 t}{{μ}_{0} {S}_{1}} + h , {m}_{+} = 2 {H}_{2} + \frac{2 t}{{μ}_{0} {S}_{2}} - h$$

$${V}_{-} = V {\vert}_{z = - {H}_{1} + Δ d} + V {\vert}_{z = {H}_{2} + Δ d} = \frac{{Mm}_{-}}{2 π {S}_{1}} \cdot \frac{9 {r}^{2} - 6 {m}_{-}^{2}}{{[ {r}^{2} + {m}_{-}^{2} ]}^{7 / 2}} + \frac{{Mm}_{+}}{2 π {S}_{2}} \cdot \frac{9 {r}^{2} - 6 {m}_{+}^{2}}{{[ {r}^{2} + {m}_{+}^{2} ]}^{7 / 2}}$$

$${m}_{-} = 2 {H}_{1} - 2 Δ d + \frac{2 t}{{μ}_{0} {S}_{1}} + h , {m}_{+} = 2 {H}_{2} + 2 Δ d + \frac{2 t}{{μ}_{0} {S}_{2}} - h$$

$${V}_{+} = V {\vert}_{z = - {H}_{1} - Δ d} + V {\vert}_{z = {H}_{2} - Δ d} = \frac{{Mm}_{-}}{2 π {S}_{1}} \cdot \frac{9 {r}^{2} - 6 {m}_{-}^{2}}{{[ {r}^{2} + {m}_{-}^{2} ]}^{7 / 2}} + \frac{{Mm}_{+}}{2 π {S}_{2}} \cdot \frac{9 {r}^{2} - 6 {m}_{+}^{2}}{{[ {r}^{2} + {m}_{+}^{2} ]}^{7 / 2}}$$

$${m}_{-} = 2 {H}_{1} + 2 Δ d + \frac{2 t}{{μ}_{0} {S}_{1}} + h , {m}_{+} = 2 {H}_{2} - 2 Δ d + \frac{2 t}{{μ}_{0} {S}_{2}} - h$$

$${ρ}_{upper} = k \frac{Δ {H}_{1}}{Δ {S}_{1}} , {ρ}_{lower} = k \frac{Δ {H}_{2}}{Δ {S}_{2}}$$

As would be understood by one of skill in the art, the exemplary equations may be modified based on the waveform generated by the EM tool 170.

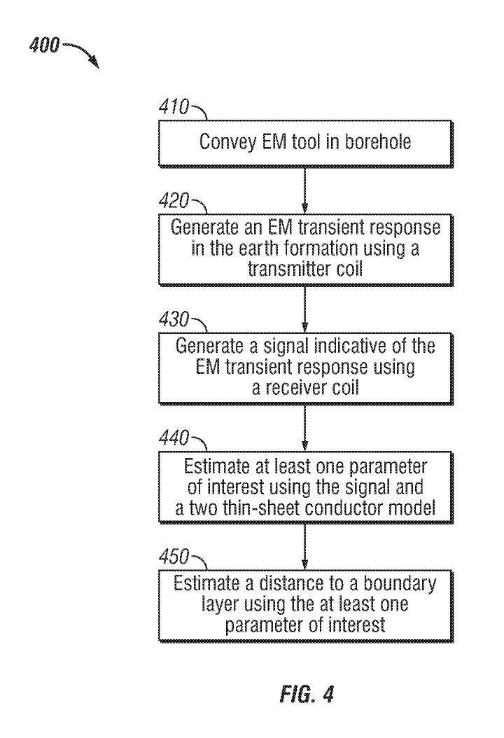

FIG. 4 shows an exemplary method 400 according to one embodiment of the present disclosure. In step 410 of method 400, an EM tool 170 may be conveyed in a borehole. The EM tool 170 may be configured for, but not limited to, conveyance in a borehole 126 on one of: (i) a wireline and (ii) a drill string 120. In step 420, an electromagnetic transient response in the earth formation 195 may be generated using transmitter coil 210. The electromagnetic transient response may be induced by varying the output to the transmitter coil 210. The transient response may be induced by any waveform as long as the waveform has a duty cycle with sufficient off-time for the transient response to be estimated. The inducing the transient response may include, but is not limited to, one or more of: (i) cycling output on-off, (ii) cycling output off-on, (iii) generating a spike, (iv) generating cyclical waveform with sharp leading edge, and (v) generating a cyclical waveform with a sharp trailing edge. In step 430, a signal may be generated by a receiver coil 220 on the EM tool 170, the signal including information indicative of the electromagnetic response of the earth formation 195. In some embodiment, transmitter coil 210 may be configured to generate the signal indicating the electromagnetic response of the earth formation 195. In some embodiments, steps 420 and 430 may be performed by a single antenna configured to cause the electromagnetic transient response in the earth formation and to generate the signal indicating the electromagnetic transient response. In embodiments using an arbitrary waveform, a mathematical operation, such as convolution to obtain the transient response signal or deconvolution of the estimated response, may be performed. In step 440, at least one parameter of interest may be estimated using the signal with a two thin-sheet conductor model. Step 440 may be performed by at least one processor. The at least one parameter of interest may include, but is not limited to, one or more of: (i) a conductance distribution (ii) a resistivity profile, and (iii) a conductivity profile. The two thin-sheet conductor model may include electromagnetic transient information obtained at one or more different depths within the borehole 126. In some embodiments, the electromagnetic transient information may be obtained with the transmitter coil 210 at least three different depths. In step 450, a boundary distance may be estimated using the at least one parameter of interest. The boundary distance may indicate a distance from a tool position to a boundary between layers with different electrical properties. The electrical properties may include, but are not limited to, one or more of: (i) conductivity and (ii) resistivity. In some embodiments, step 450 may be optional.

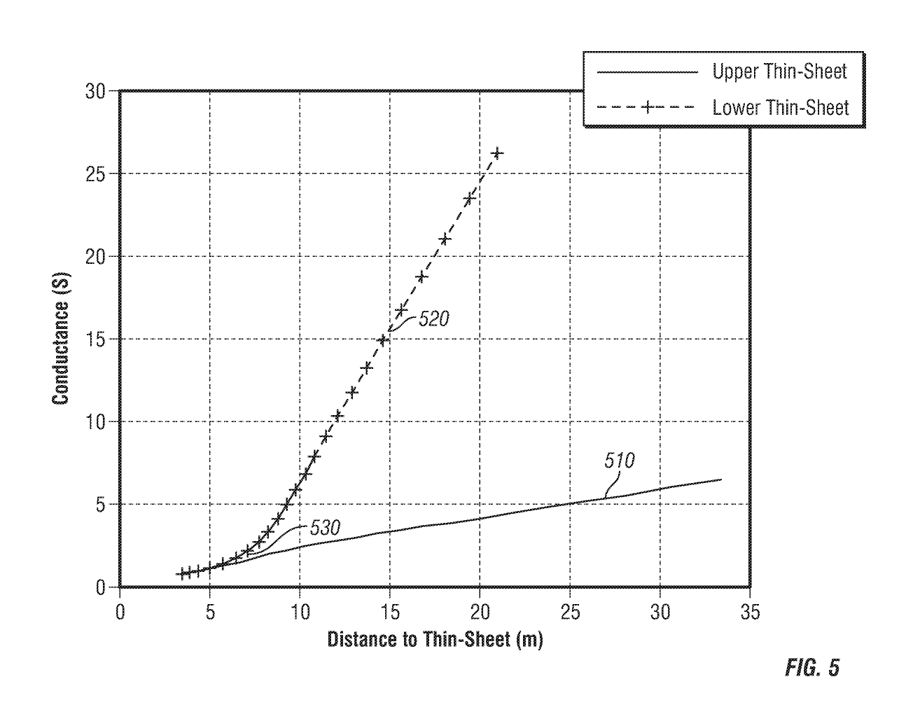

FIG. 5 shows a graph with a set of curves representing conductance varying with distance. Curve 510 shows conductance as distance increases upward from the tool in a two thin-sheet model. Curve 520 shows conductance as distance increases downward from the tool in the two thin-sheet model. The slope of the curves 510, 520 may be uniform when the conductivity of the formation is relatively unchanged. A change in the slope may indicate a boundary between layers with different electrical properties. Such a change may be observed at bend 530 in curve 520.

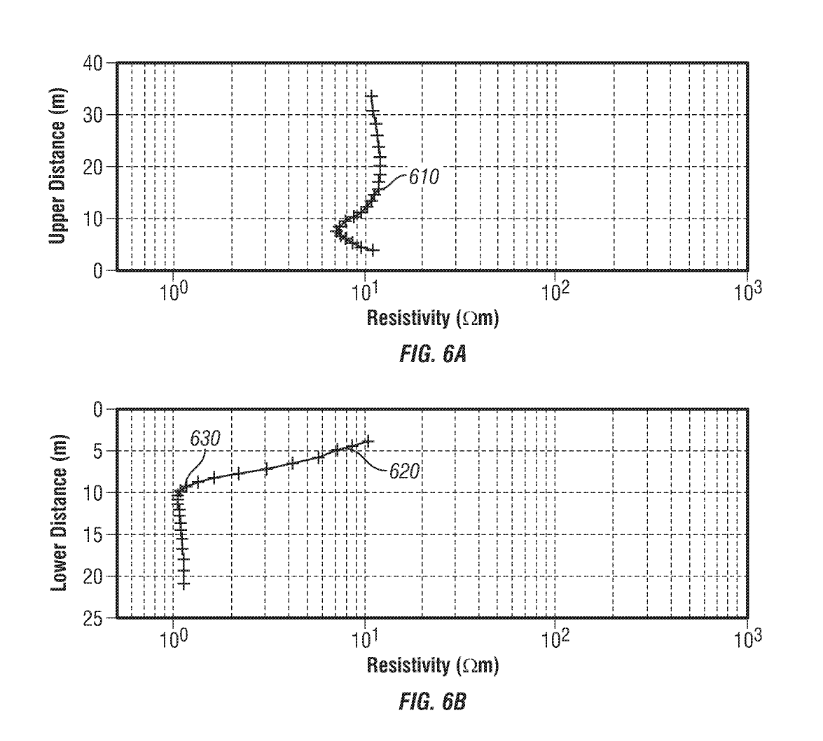

FIGS. 6A-B shows graphs with curves representing resistivity varying with distance. FIG. 6A shows curve 610 of resistivity as distance increases upward from the tool in a two thin-sheet model. FIG. 6B shows curve 620 of resistivity as distance increases downward from the tool in the two thin-sheet model. The slope change in curve 620 at bend 630 may indicate a boundary between layers with different electrical properties.

Implicit in the processing of the data is the use of a computer program implemented on a suitable machine readable medium that enables the processor to perform the control and processing. The term processor as used in this application is intended to include such devices as field programmable gate arrays (FPGAs). The machine readable medium may include ROMs, EPROMs, EAROMs, Flash Memories and Optical disks. As noted above, the processing may be done downhole or at the surface, by using one or more processors. In addition, results of the processing, such as an image of a resistivity property, can be stored on a suitable medium.

While the foregoing disclosure is directed to the one mode embodiments of the disclosure, various modifications will be apparent to those skilled in the art. It is intended that all variations be embraced by the foregoing disclosure.

What is claimed is:

1. A method of estimating at least one parameter of interest of an earth formation, comprising:
estimating the at least one parameter of interest using a two thin-sheet conductor model with electromagnetic transient information obtained using a receiver in a borehole penetrating the earth formation.

2. The method of claim 1, further comprising:
generating an electromagnetic transient response in the earth formation using a transmitter; and
obtaining the electromagnetic transient information from the electromagnetic transient response using the receiver.

3. The method of claim 3, wherein the electromagnetic transient information is obtained at least three different depths.

4. The method of claim 1, wherein the at least one parameter of interest includes at least one of: (i) a conductance distribution, (ii) a resistivity profile, and (iii) a conductivity profile.

5. The method of claim 1, further comprising:
estimating at least one boundary distance using the at least one parameter of interest.

6. The method of claim 1, further comprising:
conveying the receiver in the borehole.

7. The method of claim 1, wherein the two thin-sheet conductor model includes an upper sheet and a lower sheet, and wherein using the two thin-sheet conductor model includes estimating a conductance and a distance for the upper sheet and the lower sheet.

8. The method of claim 7, wherein estimating the conductance of and the distance to each of the two thin-sheet conductors includes solving:
$$V \approx V {\vert}_{z = - {H}_{1}} + V {\vert}_{z = {H}_{2}} = \frac{{Mm}_{-}}{2 π {S}_{1}} \cdot \frac{9 {r}^{2} - 6 {m}_{-}^{2}}{{[ {r}^{2} + {m}_{-}^{2} ]}^{7 / 2}} + \frac{{Mm}_{+}}{2 π {S}_{2}} \cdot \frac{9 {r}^{2} - 6 {m}_{+}^{2}}{{[ {r}^{2} + {m}_{+}^{2} ]}^{7 / 2}} ,$$
where
$${m}_{-} = 2 {H}_{1} + \frac{2 t}{{μ}_{0} {S}_{1}} + h , {m}_{+} = 2 {H}_{2} + \frac{2 t}{{μ}_{0} {S}_{2}} - h ,$$
V is a voltage of an electromagnetic transient detected at the receiver, M is an electric moment of a transmitter, r is a horizontal distance from the transmitter, H₁ is the distance to the upper sheet, H₂ is the distance to the lower sheet, S₁ is the conductance of the upper sheet, S₂ is the conductance of the lower sheet, μ₀ is magnetic permeability, z is a vertical distance from the transmitter, h is a vertical distance between the transmitter and the receiver, and t is time.

9. An apparatus for estimating a parameter of interest of an earth formation, comprising:
at least one antenna configured to generate an electromagnetic transient response in the earth formation and configured to generate a electromagnetic transient information based on the electromagnetic transient response; and
at least one processor configured to estimate at least one parameter of interest of the earth formation using the electromagnetic transient information.

10. The apparatus of claim 9, wherein the at least one antenna includes at least one transmitter antenna and at least one receiver antenna, the at least one transmitter antenna being configured to generate the electromagnetic transient response and the at least one receiver antenna being configured to generate the electromagnetic information based on the electromagnetic transient response.

11. The apparatus of claim 9, wherein the at least one parameter of interest includes at least one of: (i) a conductivity distribution and (ii) a resistivity profile.

12. The apparatus of claim 9, wherein the at least one processor is further configured to estimate at least one boundary distance using the at least one parameter of interest.

13. The apparatus of claim 9, further comprising:
a carrier configured to be conveyed in a borehole penetrating the earth formation, wherein the at least one transmitter and at least one receiver are disposed on the carrier.

14. A non-transitory computer-readable medium product having stored thereon instructions that, when executed by at least one processor, perform a method, the method comprising:
estimating at least one parameter of interest using a two thin-sheet conductor model with electromagnetic transient information obtained using a receiver in a borehole penetrating the earth formation.

15. The non-transitory computer-readable medium product of claim 14 further comprising at least one of: (i) a ROM, (ii) an EPROM, (iii) an EEPROM, (iv) a flash memory, and (v) an optical disk.
